(19) United States
(12) Patent Application Publication
(10) Pub. No.: US 2010/0228852 A1
(43) Pub. Date: Sep. 9, 2010

(54) Detection of Advertising Arbitrage and Click Fraud

(76) Inventors: Steven Gemelos, San Jose, CA (US); Anthony Petronelli, San Jose, CA (US); Raghvendra Savoor, Walnut Creek, CA (US)

Correspondence Address: AT&T Legal Department - HBH;Attn: Patent Docketing, One AT&T Way, Room 2A-207, Bedminster, NJ, 07921, US

(21) Appl. No.: 12/399,125

(22) Filed: Mar. 6, 2009

(51) Int. Cl. G06F 15/173

(52) U.S. Cl. 709/224; 726/22

(57) ABSTRACT

This description provides tools and techniques for detecting advertising arbitrage and click fraud. These tools may monitor packet traffic to or from subscribers to website hosting services. These tools may also analyze the packets to determine whether at least a part of the traffic is indicative of suspected click fraud affecting websites managed as part of the website hosting services.

### BACKGROUND

With the advent of Web-based advertisements accessible over the Internet, different advertisers may pay different rates to have their ads placed on various websites. Various schemes have arisen to take advantage of this disparity in advertising rates. Put differently, these schemes may attempt to benefit from arbitrage or click fraud that attempt to take advantage of these disparities in advertising rates.

Previous approaches to combat these various arbitrage or click fraud schemes have typically relied upon active intervention or participation from end-users. For example, some Internet websites (e.g., search engines) may enable these end users to download various tools by which the end-users may report suspected arbitrage or click fraud, based on their personal observations while browsing the Internet. While these previous approaches may be somewhat effective in some circumstances, they typically rely upon the active participation of end users. In cases where end-users do not participate, these previous approaches may fail.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This description provides tools and techniques for detecting advertising arbitrage and click fraud. These tools may provide apparatus for monitoring packet traffic to or from subscribers to website hosting services. These tools may also analyze the packets to determine whether at least a part of the traffic is indicative of suspected click fraud affecting websites managed as part of the website hosting services

Other apparatus, systems, methods, and/or computer program products according to embodiments will be or become apparent to one with skill in the art upon reviewing the following drawings and Detailed Description. It is intended that all such additional apparatus, systems, methods, and/or computer program products be included within this description, be within the scope of the claimed subject matter, and be protected by the accompanying claims.

### BRIEF DESCRIPTION OF THE DRAWINGS

FIG. 1 is a combined block and flow diagram illustrating systems or operating environments for detection of advertising arbitrage and click fraud in scenarios involving subscribers to internet access services.

FIG. 2 is a combined block and flow diagram illustrating systems or operating environments for detection of advertising arbitrage and click fraud in scenarios involving hosted website services.

FIG. 3 is a combined block and flow diagram illustrating example arbitrage and/or click fraud scenarios.

FIG. 4 is a flow diagram illustrating example processes related to detection of advertising arbitrage and click fraud.

### DETAILED DESCRIPTION

The following detailed description is directed to methods, systems, and computer-readable media (collectively, tools and/or techniques) for detection of advertising arbitrage and click fraud. While the subject matter described herein is presented in the general context of program modules that execute in conjunction with the execution of an operating system and application programs on a computer system, those skilled in the art will recognize that other implementations may be performed in combination with other types of program modules.

Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

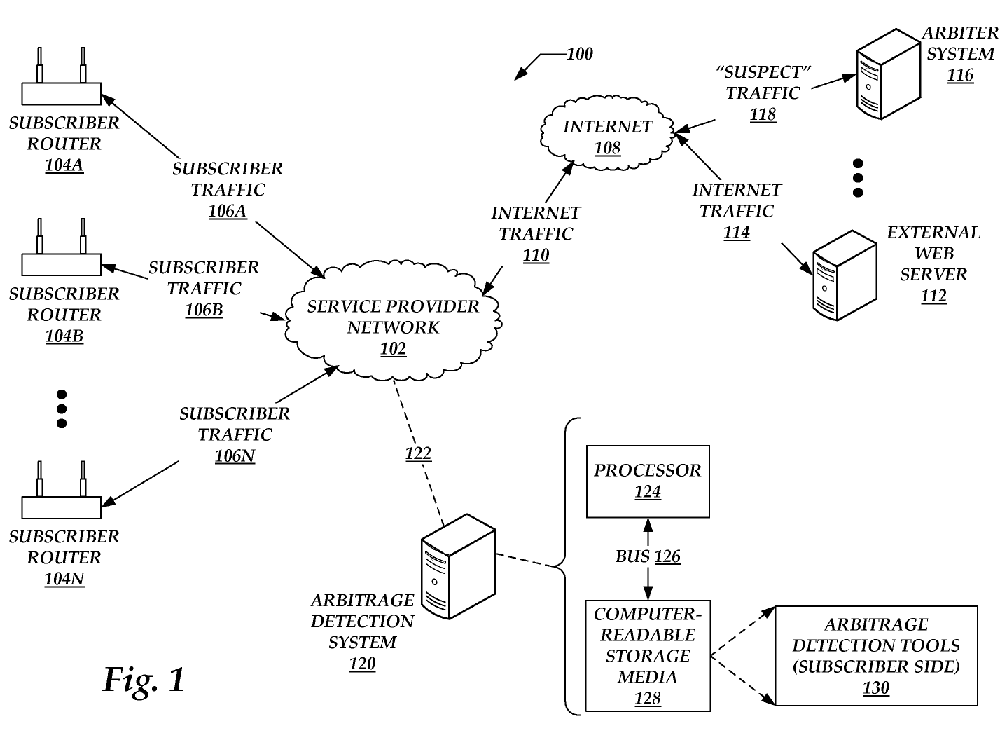

FIG. 1 illustrates systems or operating environments, denoted generally at 100, for detection of advertising arbitrage and click fraud. In the examples shown in FIG. 1, these systems 100 may include one or more networks 102 maintained by, for example, an Internet service provider (ISP). This ISP may enable any number of subscribers to access the networks 102 through respective individual access points, including but not limited to subscriber access devices such as routers 104a, 104b, and 104n (collectively, routers 104). These routers 104 may support wired or wireless access to the networks 102, as suitable in different implementations.

FIG. 1 provides examples of subscriber traffic directed to and/or from respective subscribers (including users of subscriber devices), the traffic being referenced at 106a, 106b, and 106n (collectively, subscriber traffic 106). In the description that follows, the term “subscriber” includes any user of a subscriber device having access to the subscriber's account. The subscriber traffic 106 may include, for example, any number of frames, packets, or any other data structures suitable for transporting subscriber traffic to and through the networks 102. Without limiting possible implementations, this description proceeds with reference to “packets”. However, implementations of this description may process other data structures without departing from the scope and spirit thereof. Moreover, the exact format and layout of these data structures (e.g., packets) may vary as appropriate in different implementations, and accordingly is not described in detail here.

The networks 102 may enable the subscribers to access one or more external global communications networks, with FIG. 1 providing an example as Internet 108. FIG. 1 generally denotes at 110 directional traffic between the Internet 108 and the networks 102 that are maintained by the ISP.

As shown in FIG. 1, subscribers to services provided by the ISP may access the Internet 108 through the networks 102. More specifically, these subscribers may access any number of external Web servers, with FIG. 1 providing a representative example at 112. Internet traffic flowing to and/or from such external Web servers 112 is denoted at 114.

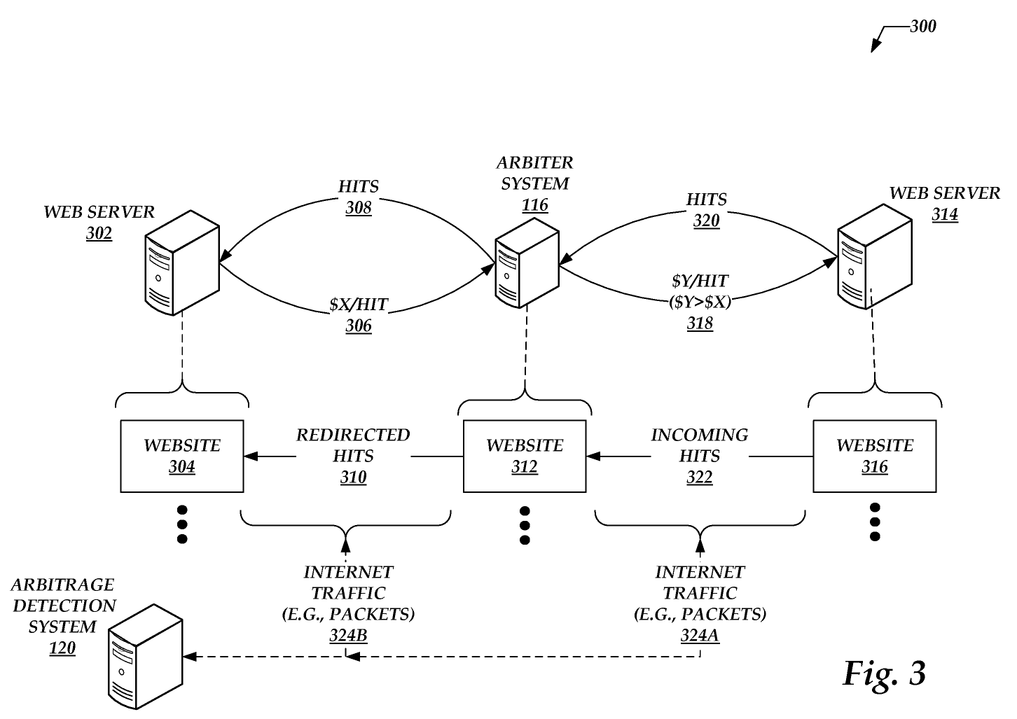

In addition to the external Web servers 112, the subscribers may also access (perhaps inadvertently) any number of arbiter systems 116. Internet traffic flowing to and/or from such arbiter systems 116 is denoted at 118. The arbiter systems 116 are described in more detail in FIG. 3 below. However, in overview, the arbiter systems 116 may be engaged in some type of arbitrage involving the Internet traffic 118. Without limiting possible implementations, examples of such arbitrage may include scenarios in which the arbiter system 116 receives a first per-click payment in exchange for a click stream outgoing from the arbiter system 116, and provides a second per-click payment in exchange for a click stream incoming to the arbiter system 116. In scenarios in which the first per-click payment exceeds the second per-click payment, an arbitrage scenario results, and the arbiter system 116 profits from this arbitrage.

To the extent that the arbiter system 116 is improperly profiting from the above arbitrage scenario, at least a portion of the Internet traffic 118 to and/or from the arbiter system 116 may be characterized as “click fraud”. Accordingly, FIG. 1 labels the traffic 118 as “suspect”, to represent that at least a portion of this traffic 118 may result from arbitrage and/or click fraud.

The systems or operating environments 100 may include any number of arbitrage detection systems 120 that are, as described in further detail below, operative to detect various arbitrage and/or click fraud scenarios. Evidence of ongoing arbitrage or click fraud scenarios may be manifested within the subscriber traffic 106, as well as the Internet traffic 110, 114, and/or 118. The arbitrage detection systems 120 may be incorporated into the service provider network 102, or may operate externally to the network 102. FIG. 1 generally represents either of these scenarios at 122.

Turning to the arbitrage detection systems 120 in more detail, these systems 120 may include one or more processors 124, which may have a particular type or architecture, chosen as appropriate for particular implementations. The processors 124 may couple to one or more bus systems 126 chosen for compatibility with the processors 124.

The arbitrage detection systems 120 may also include one or more instances of a computer-readable storage medium or media 128, which couple to the bus systems 126. The bus systems 126 may enable the processors 124 to read code and/or data to/from the computer-readable storage media 128. The media 128 may represent apparatus in the form of storage elements that are implemented using any suitable technology, including but not limited to semiconductors, magnetic materials, optics, or the like. The media 128 may include memory components, whether classified as RAM, ROM, flash, or other types, and may also represent hard disk drives.

The storage media 128 may include one or more modules of instructions that, when loaded into the processor 124 and executed, cause the arbitrage detection systems 120 to perform various techniques related to detecting advertising arbitrage and click fraud. FIG. 1 provides examples of such software modules at 130. As detailed throughout this description, these modules of instructions 130 may also provide various means, tools, or techniques by which the arbitrage detection systems 120 may detect advertising arbitrage and click fraud, using the components, flows, and data structures discussed in more detail throughout this description.

For convenience of discussion only this description provides examples in which the tools and techniques described herein are implemented in software. However, it is noted that these tools and techniques may also be implemented in hardware and/or circuitry without departing from the scope and spirit of this description.

The modules of instructions 130 may provide arbitrage detection tools, operable within the systems or operating environments 100 to detect scenarios in which the subscriber traffic 106 may be affected by click fraud or arbitrage traceable to one or more arbiter systems 116. Accordingly, FIG. 1 labels block 130 as “subscriber side” arbitrage detection tools.

As noted above, specific examples of click fraud and/or arbitrage are provided below with FIG. 3. However, in overview, the subscriber traffic 106 may be affected by click fraud or arbitrage in several different scenarios, with the following examples are vided only for purposes of illustrating this discussion, but not to limit possible implementations or applications of the description herein. For example, a given subscriber may wish to access a desired website, and accordingly may key into a browser a Uniform Resource Locator (URL) address associated with the Web server 112 that services this desired website. However, the arbiter system 116 may operate any number of arbiter websites, and may redirect traffic destined for the Web server 112 through these arbiter websites before this traffic reaches the Web server 112. Typically, this traffic redirection constitutes a form of click fraud that provides revenue and/or profit for the arbiter system 116.

In other examples, computer systems associated with subscribers may become infected with malware, “bots”, or other types of malicious software under the direction of the arbiter systems 116. In these latter examples, these subscriber systems may unwittingly be commandeered by the arbiter systems 116, such that website traffic is diverted or redirected through these commandeered systems. Once again, this redirected Web traffic results in a form of click fraud that benefits the arbiter systems 116.

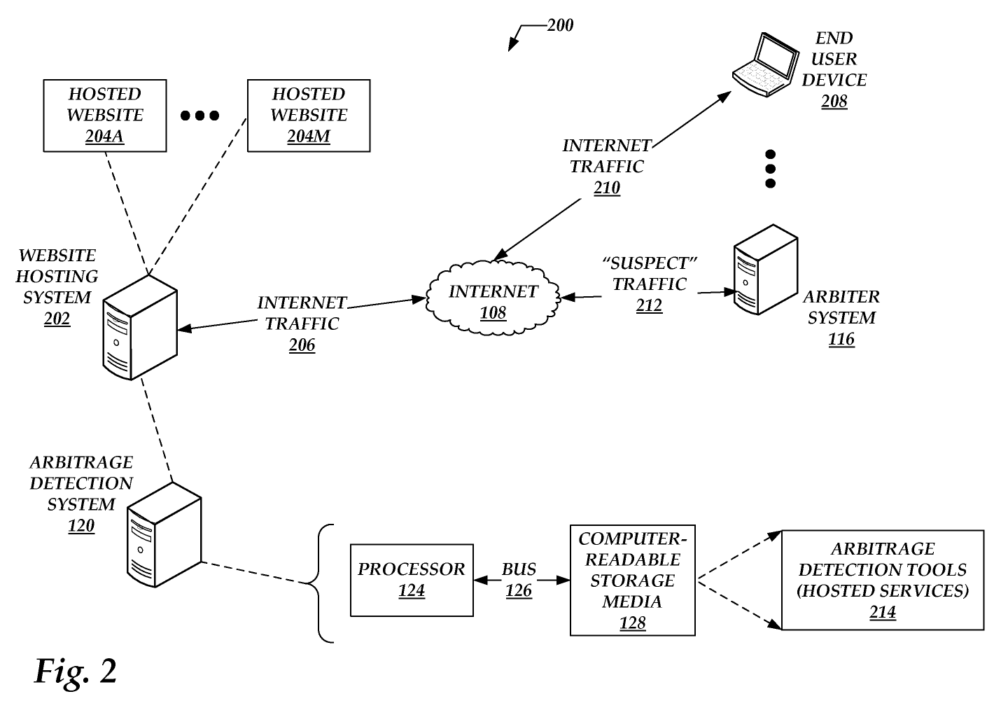

The foregoing discussion provides various non-limiting examples in which the arbitrage detection systems 120 may operate from the perspective of subscribers to the networks 102 operated by ISPs. However, implementations of this description may also detect advertising arbitrage and click fraud from the perspective of subscribers to hosted website services. Examples of these latter scenarios are now discussed with FIG. 2.

FIG. 2 illustrates systems or operating environments, denoted generally at 200, for detection of advertising arbitrage and click fraud in scenarios involving hosted website services. For convenience of description and reference, but not to limit possible implementations, FIG. 2 may carry forward certain features from previous Figures, and may denote them using the same reference numbers.

Turning to FIG. 2 in more detail, the systems or operating environments 200 may include one or more website hosting systems 202. Among possible other functions, the website hosting systems 202 may operate any number of websites 204a and 204m (collectively, hosted websites 204) on behalf of third-party clients (not shown in FIG. 2). For example, these third-party clients may be online merchants who do not wish to incur the expense and inconvenience of operating their own websites. Instead, these third-party clients may contract for hosted services with the website hosting system 202. Accordingly, Web traffic to and/or from the Internet 108 that is destined for the hosted websites 204 may land on the website hosting system 202, as represented generally at 206.

As shown in FIG. 2, any number of end user devices 208 that have Internet connectivity may access and interact with the hosted websites 204 through the website hosting systems 202. FIG. 2 generally represents at 210 Internet traffic to and/or from these end user devices 208. However, arbiter systems 116 (carried forward from FIG. 1 without limiting possible implementations) may also redirect at least a portion of this Internet traffic 210 destined for the hosted websites 204, resulting in “suspect” click stream traffic 212 that fraudulently benefits the arbiter systems 116.

FIG. 2 carries forward the arbitrage detection system 120 from FIG. 1 only to facilitate reference and description, but not to limit possible implementations. In addition, FIG. 2 carries forward the processor 124, bus systems 126, and computer readable storage media 128. The foregoing description of these elements provided with FIG. 1 applies equally to the arbitrage detection systems 120 as shown in FIG. 2. However, as shown in FIG. 2, the computer-readable storage media 128 may include software modules 214 that operate from the perspective of hosted services, as compared from the perspective of subscribers as shown in FIG. 1.

Having described the various operating environments shown in FIGS. 1 and 2, the discussion now proceeds to a more detailed description of illustrative arbitrage scenarios that the arbitrage detection systems 120 may detect. This description is now provided with FIG. 3.

FIG. 3 illustrates example arbitrage and/or click fraud scenarios, denoted generally at 300. For convenience of description and reference, but not to limit possible implementations, FIG. 3 may carry forward certain features from previous Figures, and may denote them using the same reference numbers. For example, FIG. 3 carries forward the arbiter system 116 and the arbitrage detection system 120 from FIGS. 1 and 2.

In providing FIG. 3 and this related description, it is noted that implementations of this description are not limited to addressing only the arbitrage scenarios provided in these examples. Instead, implementations of this description may address other arbitrage scenarios without departing from the scope and spirit of this description.

Turning to FIG. 3 in more detail, the arbiter system 116 may enter into a first agreement involving a Web server 302 hosting a first website 304. Under the terms of this first agreement, the first website 304 may pay the arbiter system 116 a given per-click rate (e.g., $1.00 per click) in exchange for Internet traffic directed from the arbiter system 116 to the website 304. FIG. 3 represents at 306 payments under the first agreement, and represents at 308 traffic from the arbiter system 116 to the website 304. In addition, FIG. 3 represents at 310 hits that are redirected from a website 312, which is associated with the arbiter system 116, to the website 304.

The arbiter system 116 may also enter into at least a second agreement involving a Web server 314 hosting a second website 316. under the terms of this second agreement, the arbiter system 116 may pay the second website 316 a second per-click rate (e.g., $0.50 per click) in exchange for Internet traffic directed from the second website 316 to the arbiter system 116. FIG. 3 represents at 318 payments under the second agreement, and represents at 320 traffic from the Web server 314 to the arbiter system 116. In addition, FIG. 3 represents at 322 hits that are redirected from the website 316 to the website 312, which is operated by the arbiter system 116.

In illustrative arbitrage scenarios, the first payment 306 from the website 304 to the arbiter system 116 would exceed the second payment from the arbiter system 116 to the website 316. In the above example, the arbiter system 116 would generate a $0.50 profit on each hit redirected from the website 316 through the arbiter website 312 ultimately landing on the website 304. In effect, the arbiter system 116 is able to profit from a relatively generous fee paid by the website 304 to receive clicks, as compared to a relatively lower fee paid by the arbiter system 116 to receive clicks from the website 316.

The arbitrage detection system 120 may operate in general by monitoring Internet traffic. In some implementation scenarios, the arbitrage detection system 120 may monitor traffic (e.g., 322) flowing into possible arbiter systems 116. In other scenarios, the arbitrage detection system 120 may monitor traffic (e.g., 310) flowing from possible arbiter systems 116. FIG. 3 generally denotes monitored Internet traffic at 324a and 324b (collectively, monitored Internet traffic 324).

In example implementations, the arbitrage detection system may employ deep packet inspection (DPI) techniques to analyze or monitor packets passing by a given inspection point. DPI techniques may involve analyzing a data and/or header portion of a packet as it passes the inspection point, searching for evidence of the types of click fraud or arbitrage described herein. These DPI techniques may also collect statistical information supporting the foregoing packet analysis. In general, but not to limit possible implementations, DPI techniques may be distinguished from shallow packet inspection, which typically analyzes only the header portions of packets.

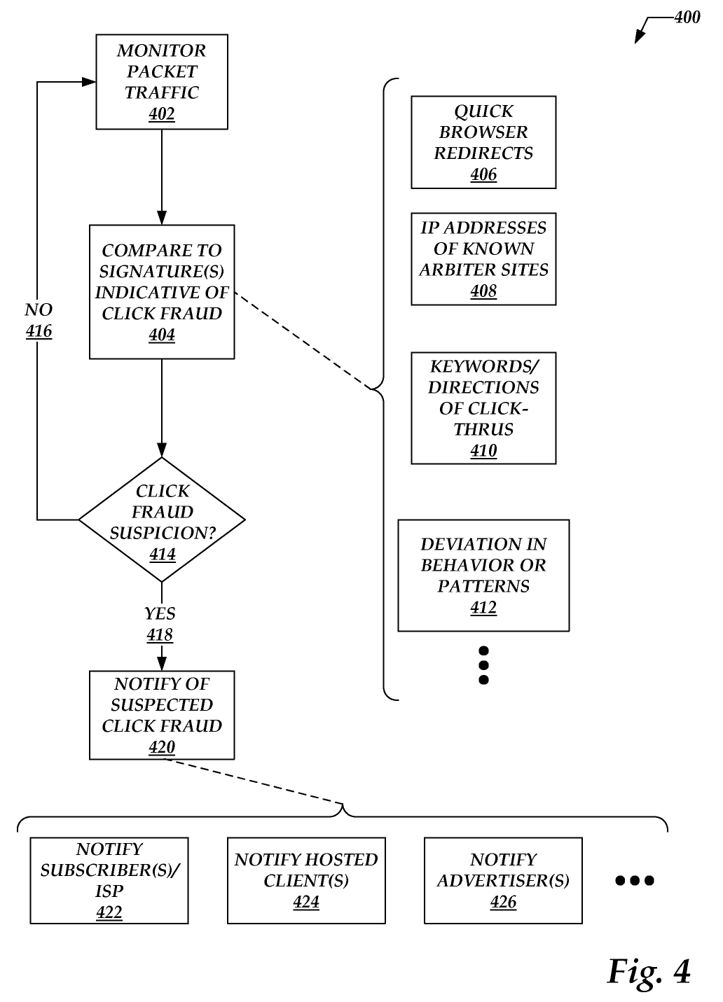

The discussion now turns to descriptions of process flows by which the arbitrage detection systems 120 may process this monitored Internet traffic 324 in connection with detecting arbitrage and click fraud. This description is now provided with FIG. 4.

FIG. 4 illustrates example processes, denoted generally at 400, related to detecting arbitrage and click fraud. Referring briefly back to FIGS. 1 and 2, the process flows 400 may be understood as elaborating further on processing performed by the arbitrage detection tools 130 and 214.

Turning to the processes 400 in more detail, block 402 represents monitoring network or Internet traffic. For example, block 402 may include monitoring a flow of packets from a convenient point within a service provider network (e.g., 102 in FIG. 1) or an external public Internet (e.g., 108 in FIGS. 1 and 2).

Block 404 represents comparing the monitored network traffic to pre-existing signatures or performance characteristics indicative of arbitrage scenarios and/or click fraud. In different illustrative, but non-limiting, scenarios, block 404 may include monitoring for sequences of relatively quick browser redirects, represented generally at 406. For example, referring briefly back to FIG. 3, examples of browser redirects may include scenarios in which a given end-user begins browsing at the website 316 and activates a link believed to be associated with the website 304. In turn, however, this link is actually associated with one or more arbitrage websites 312. Thus, when the end user activates the link, the end-user is directed through one or more arbitrage websites 312, and then ultimately landing at the destination website 304. Typically, these redirect actions happen far more quickly than would be possible if the end-user or manually clicking through sites, and the end-user may or may not be aware of the website redirection. The speed with which these redirect operations occur may suggest that the redirects are occurring automatically, rather than manually. Nevertheless, under the arbitrage scenarios described above, the arbiter system 116 may profit from these re-directions.

An additional example, block 404 may include monitoring packets for Internet protocol (IP) addresses associated with suspected arbitrage websites (e.g., 312) or arbiter systems (e.g., 116). In some example scenarios, block 406 may detect a sequence of quick browser redirects, with the process flows 400 flagging these redirects as suspicious. However, block 408 may further examine the IP addresses associated with these browser redirects, and may identify at least one suspected arbitrage website 312 involved in the browser redirects. Thus, the analysis performed in block 408 may further reinforce suspicions resulting from analysis performed in block 406.

In some implementation scenarios, block 408 may operate somewhat independently from block 406. For example, if a given website appears frequently enough in suspicious browser redirect scenarios, a given website may be added to a list of known or suspected arbitrage websites.

Block 404 may further include analyzing monitored packets, to determine whether these packets contain keywords or other identifiers associated with high profile or well-known online websites, as represented generally by block 410. In example scenarios, the arbiter systems 116 may target users who frequent such websites. Thus, monitored Internet traffic (e.g., 324 in FIG. 3) may include the names, URLs, or other identifying indicia associated with such websites. In addition, directions in which monitored Internet traffic is proceeding may reveal suspicious activity that may be associated with arbitrage or click fraud.

Block 404 may also include monitoring for any unexpected or unexplained patterns or deviations in browser behavior, as represented in block 412. For example, referring to the subscriber scenarios shown in FIG. 1, a given subscriber may exhibit certain browsing habits. These browsing habits may constitute a behavior baseline associated with the given subscriber. However, block 412 may detect that, at some point, a given subscriber's browsing habits have changed. If the circumstances surrounding these changes do not otherwise explain such deviations, these deviations may be evidence of the subscriber's computer system having been infected with malware, bots, or the like. Such infections may lead to the subscriber's computer system becoming involved in arbitrage scenarios such as those shown in FIG. 3. For example, the Internet traffic 324a may be redirected through an IP address associated with the infected computer system.

Decision block 414 represents evaluating whether the monitored Internet traffic 324 raises some threshold level of suspicion of arbitrage or click fraud. For example, if block 404 (as well as blocks 406-412) does not result in any significant suspicion of arbitrage or click fraud, the process flows 400 may take No branch 416 to return to block 402. However, from decision block 414, if monitoring one or more network packets raises suspicion of arbitrage or click fraud, the process flows 400 may take Yes branch 418 to block 420.

Block 420 represents providing some notification of suspected arbitrage and/or click fraud. the processing represented in block 420 may take different forms in different implementations, depending on whether a given implementation is relatively subscriber-centric (e.g., tools 130 shown in FIG. 1) or focuses more on posting scenarios (e.g., tools 214 in FIG. 2). For example, assuming a subscriber-centric scenario, block 422 represents notifying a subscriber that his or her computing system has apparently been involved in activity related to possible arbitrage and/or click fraud. Explanations for this activity may include malware infections, or the like. The notification may prompt the subscriber to execute suitable anti-malware measures (e.g., virus scans, or the like), in an effort to cleanse a possible infection.

Generalizing beyond a given subscriber, if malware infections are sufficiently commonplace among a given base of subscribers serviced by a given ISP, block 422 may include notifying the ISP about these infections. Given this notification, the ISP may take remedial measures, such as making anti-malware utilities available to subscribers, configuring routers or other access points (e.g., 104 in FIG. 1) to reduce the risk of future malware infections, block packets having IP addresses associated with suspected arbitrage websites, as well as other possible precautions.

Block 420 may also include notifying hosted clients, as represented generally at block 424. More specifically, block 424 may be applicable hosted services scenarios, such as those shown in FIG. 2. In different possible arbitrage scenarios, a given hosted services client may have its website (e.g., 204 in FIG. 2) as the destination of one or more user devices (e.g., 208 in FIG. 2). However, if browsers seeking to access the client's website are instead redirected through one or more arbitrage websites, this may suggest that the client is paying fees to an arbiter system that are high enough to support this type of arbitrage. This feedback may prompt the hosted client to reduce fees paid to the arbiter system, thereby undercutting the motivation for the arbitrage scheme.

Block 420 may also include notifying advertisers or other interested parties, as represented generally at block 426. The parties notified in block 426 may be, for example, the parties other than subscribers, ISPs, or hosted clients. For example, a given advertiser that is neither a subscriber nor a hosted client may nevertheless benefit from knowing that advertising fees paid by the advertiser may be supporting arbitrage scenario under which an arbiter system is profiting. Given this information, the advertiser may lower or otherwise normalize its advertising fees as paid out to third parties.

In other scenarios, an advertiser (e.g., 314 and/or 316 and FIG. 3) may receive payments unwittingly as part of an arbitrage or click fraud scheme. In such scenarios, block 426 may include notifying such advertisers. Given such notification, these advertisers may benefit from such notification, for example, to avoid further entanglement in such arbitrage or click fraud schemes.

In general, the notification provided by block 420 may include identifications of any suspected arbitrage websites 312 and/or suspected arbiter systems 116. Given this information, recipients of these notifications may take any suitable precautions, which may include, but are not limited to further investigating the status of the websites and/or systems identified in the notifications.

Having provided the above description of FIGS. 1-4, it is noted that the tools and techniques described herein for detecting arbitrage and click fraud may transform representations of monitored packet flow into notifications of suspected arbitrage and/or click fraud evidenced by these packets. In addition, the tools described herein may operate in connection with physical machines, for example, the arbitrage detection systems 120. Moreover, these tools and techniques may operate in an automated or automatic fashion, in contrast to previous techniques that replied upon the active participation of end users to report suspected click fraud or advertising arbitrage. Put differently, these tools and techniques may automatically analyze and detect evidence of suspected click fraud or arbitrage, without participation of the end-users in such analysis or detection.

Based on the foregoing, it should be appreciated that apparatus, systems, methods, and computer-readable storage media for detecting arbitrage and click fraud are provided herein. Although the subject matter presented herein has been described in language specific to computer structural features, methodological acts, and computer readable media, it is to be understood that the subject matter defined in the appended claims is not necessarily limited to the specific features, acts, or media described herein. Rather, the specific features, acts and mediums are disclosed as example forms of implementing this description.

The subject matter described above is provided by way of illustration only and should not be construed as limiting. Various modifications and changes may be made to the subject matter described herein without following the example embodiments and applications illustrated and described, and without departing from the true spirit and scope of the claimed subject matter, which is set forth in the following claims.

What is claimed is:

1. Apparatus comprising at least one computer-readable storage medium comprising computer-executable instructions stored thereon that, when executed by a general-purpose computer, transform the general-purpose computer into a special-purpose computer that is operative to:
monitor packet traffic to or from a plurality of subscribers to an Internet service provider (ISP); and
analyze at least one of the packets to determine whether at least part of the packet traffic is indicative of suspected click fraud affecting at least one website visited by at least one of the subscribers.

2. The apparatus of claim 1, wherein the at least one computer-readable storage medium further comprises instructions that, when executed by the general purpose computer, transform the general-purpose computer into the special-purpose computer that is operative to notify at least one of the subscribers in the event that computing systems associated with the notified subscriber is involved with the suspected click fraud.

3. The apparatus of claim 1, wherein the special-purpose computer that is operative to analyze at least one of the packets detects a plurality of automatic browser redirect operations by which at least one of the subscribers is navigated to the website.

4. The apparatus of claim 3, wherein the special-purpose computer that is operative to detect a plurality of automatic browser redirect operations detects that the browser redirect operations occurred more quickly than a typical pattern associated with the at least one subscriber.

5. The apparatus of claim 3, wherein the special-purpose computer that is operative to detect a plurality of automatic browser redirect operations detects that an Internet protocol (IP) address associated with an arbiter system is involved in the browser redirect operations.

6. The apparatus of claim 1, wherein the special-purpose computer that is operative to analyze at least one of the packets detects at least one deviation in a browsing pattern associated with the at least one subscriber.

7. The apparatus of claim 1, wherein the at least one computer-readable storage medium further comprises instructions that, when executed by the general purpose computer, transform the general-purpose computer into the special-purpose computer that is operative to detect that a computer system associated with the at least one of the subscribers is infected by malware that is causing the suspected click fraud.

8. The apparatus of claim 2, wherein the special-purpose computer that is operative to notify notifies at least the one of the subscribers, or an ISP serving at least some of the subscribers, that a computing system associated with the at least one subscriber is involved in the suspected click fraud.

9. The apparatus of claim 1, wherein the at least one computer-readable storage medium further comprises instructions that, when executed by the general purpose computer, transform the general-purpose computer into the special-purpose computer that is operative to identify at least one arbiter system involved in the suspected click fraud.

10. The apparatus of claim 9, wherein the special-purpose computer that is operative to identify provides at least one notification identifying the arbiter system.

11. Apparatus comprising at least one computer-readable storage medium comprising computer-executable instructions stored thereon that, when executed by a general-purpose computer, transform the general-purpose computer into a special-purpose computer that is operative to:
monitor packet traffic to or from a plurality of subscribers to website hosting services; and
analyze at least one of the packets to determine whether at least a part of the traffic is indicative of suspected click fraud affecting at least one hosted website.

12. The apparatus of claim 11, wherein the at least one computer-readable storage medium further comprises instructions that, when executed by the general purpose computer, transform the general-purpose computer into the special-purpose computer that is operative to notify at least one of the subscribers that at least one hosted website is affected by the suspected click fraud.

13. The apparatus of claim 11, wherein the special-purpose computer is operative to notify at least one advertiser that at least a portion of a click stream incoming to or outgoing from the advertiser is suspected click fraud.

14. The apparatus of claim 11, wherein the at least one computer-readable storage medium further comprises instructions that, when executed by the general purpose computer, transform the general-purpose computer into the special-purpose computer that is operative to identify least one arbiter system involved in the suspected click fraud.

15. The apparatus of claim 14, wherein the at least one computer-readable storage medium further comprises instructions that, when executed by the general purpose computer, transform the general-purpose computer into the special-purpose computer that is operative to provide at least one notification identifying the arbiter system.

16. The apparatus of claim 11, wherein the special-purpose computer is operative to detect a plurality of automatic browser redirect operations by which at least one browser is navigated to the hosted website.

17. The apparatus of claim 16, wherein the special-purpose computer is operative to detect that the browser redirect operations occurred more quickly than a typical pattern associated with the browser, and to detect that an Internet protocol (IP) address associated with an arbiter system is involved in the browser redirect operations.

18. The apparatus of claim 11, wherein the instructions to analyze include instructions to detect at least one deviation in a browsing pattern associated with at least one browser.

19. A computer-implemented method comprising:
monitoring packet traffic to or from a plurality of subscribers to website hosting services; and
analyzing at least one of the packets to determine whether at least a part of the traffic is indicative of suspected click fraud affecting at least one hosted website.

20. The computer-implemented of claim 19, further comprising identifying at least one arbiter system involved in the suspected click fraud.
